(19) United States
(12) Patent Application Publication
(10) Pub. No.: US 2026/0186753 A1
(43) Pub. Date: Jul. 2, 2026

(54) GENERATING AN ARTIFICIAL INTELLIGENCE CONVERSATION MODEL FROM CLOUD DEPLOYMENT EVENTS AND ACTIONS

(71) Applicant: International Business Machines Corporation, Armonk, NY (US)

(72) Inventors: Shabna Madathil Thattantavida, Bangalore (IN); Balaji Sankar Kumar, Bangalore (IN); Gourab Sarkar, Purulia (IN); Akshat Dixit, Lucknow (IN)

(21) Appl. No.: 19/008,071

(22) Filed: Jan. 2, 2025

(51) Int. Cl. G06F 8/41

(52) U.S. Cl. CPC G06F 8/433

(57) ABSTRACT

Mechanisms are provided to generate an artificial intelligence (AI) conversation model based on learned relationships between actions, components, and events in complex software systems. The mechanisms generate a dependency graph data structure for the complex software system, which comprises components provided by a plurality of different providers. The mechanisms collect event and action data from the components of the complex software system and identify key fields for each event in the event and action data. The mechanisms generate one or more action-component-event (ACE) relationship mappings based on the event and action data and the key fields, and generate one or more AI conversation paths based on the ACE relationship mappings. The mechanisms compile the AI conversation paths into an AI conversation model for execution by an AI conversational system.

### BACKGROUND

The present application relates generally to a data processing apparatus and method and more specifically to a computing tool and computing tool operations/functionality for generating an artificial intelligence (AI) conversation model from cloud deployment events and actions.

Applications are increasingly complex. Modern technologies that operate to compartmentalize applications enable improved solutions to problems, but often lead to increased complexity. For example, with the advent of microservices, cloud computing, and the like, many applications now comprise various components provided by various providers and combined in various ways to achieve an overall function of the application.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises generating a dependency graph data structure for a complex software system, wherein the complex software system comprises components provided by a plurality of different providers. The method further comprises collecting event and action data from the components of the complex software system specified in the dependency graph data structure. The method also comprises identifying key fields for each event in the event and action data, and generating one or more action-component-event (ACE) relationship mappings based on the event and action data and the key fields. In addition, the method comprises generating one or more artificial intelligence (AI) conversation nodal paths based on the ACE relationship mappings, and compiling the one or more AI conversation nodal paths into an AI conversation model execution by an AI conversational system.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram of an artificial intelligence (AI) conversation model generator in accordance with one illustrative embodiment;

FIG. 3 is an example diagram of a dependency graph of a complex software system in accordance with one illustrative embodiment;

FIGS. 4A-4C are example tables of events in accordance with one illustrative embodiment;

FIG. 5 is an example table illustrating an action taken for a component in accordance with one illustrative embodiment;

FIGS. 6A-6C are example plots for events and actions in accordance with one illustrative embodiment;

FIG. 7 is an example diagram of an event table data structure after causal inference in accordance with one illustrative embodiment;

FIGS. 8A and 8B are example diagrams of a table data structure corresponding to the identification of verbs from the event table data structure based on value change patterns in accordance with one illustrative embodiment;

FIGS. 9A and 9B are example diagrams of table data structures corresponding to the identification nouns and listed entities in accordance with one illustrative embodiment;

FIG. 10 is an example diagram of a dialog node path for an AI conversation model in accordance with one illustrative embodiment;

FIG. 11 is a flowchart outlining an example operation of an AI conversation model generator in accordance with one illustrative embodiment;

FIG. 12 is a flowchart outlining an example operation for generating action-component relationships in accordance with one illustrative embodiment; and

FIG. 13 is a flowchart outlining an example operation for AI conversation model generation in accordance with one illustrative embodiment.

### DETAILED DESCRIPTION

The illustrative embodiments provide a computing tool and computing tool operations/functionality for generating an artificial intelligence (AI) conversation model from complex software system component events and actions, such as a cloud deployment application's events and actions, for example. The computing tool operates to learn relationships between actions, components, and events and convert these relationships into AI conversation paths that link intents with entities and reply nodes of an AI conversation system. In this way, when similar intents are identified in a user's submitted request or question to the AI conversation system, with regard to similar entities, an appropriate reply node may be invoked to provide a response to the user's request/question based on the learned action-component-event relationships.

The challenge for a developer of complex software systems is to have a comprehensive knowledge repository with guidance on how to diagnose a software system problem and how to determine what actions need to be taken when such problems arise. Many times, the issues experienced by software systems are known to developers and are repeatable, however even in such cases, the situations can become complex due to the dynamic nature of software in various environments and the possibility of new behaviors and unknown states being encountered. As a result, there is a need to continuously perform root cause analysis of problems as they arise, determine their impact, and determine which actions satisfactorily address these problems. Moreover, there is a need to update the knowledge repository for use by others when encountering such problems.

This process of maintaining and updating the knowledge repository is a very time consuming and resource intensive task which is problematic when one considers the critical nature of many of these problems and the fact that time is of the essence in resolving these issues. That is, the critical nature of production issues can impact the resiliency of a computing system. Moreover, with the complex nature of software systems, often involving multiple different applications provided by multiple different providers and having various levels of dependencies between the applications, such as in the case of cloud-based solutions, the ability to compile the knowledge repository and utilize it to address specific problems in these complex systems is beyond the capabilities of human beings through manual efforts. Thus, there is a need for automated computing tools that can leverage artificial intelligence (AI) to facilitate the development of a knowledge repository and the providing of automated AI conversational system to work with developers in addressing problems encountered with complex software systems as they arise.

The illustrative embodiments described herein provide an improved computing tool and improved computing tool operations/functionality to construct a dynamic deployment knowledge base by applying AI on the application deployment dependencies, components interaction, component data-flow and events, actions and application state, at any given point in time. The interaction and state of components, events, and actions is learned by the AI mechanisms over a period of time which results in the establishment of relationships between events, actions, and component state. These learned and established relationships are then used to build an AI conversation model.

The illustrative embodiments operate dynamically with learning by AI mechanisms as opposed to the use of static rules and thresholds for reacting to issues as they arise. That is, with static rules and thresholds, one can configure the thresholds for various factors on components and these thresholds may be used to determine when they are reached. In response to these thresholds being reached, a predefined action may be triggered. However, this approach relies on static rules, thresholds, and predetermined actions to be performed on the same components that trigger the predefined actions. In contrast, the illustrative embodiments leverage machine learning of past experiences dynamically and recommends actions that should be performed not just on the same triggering components, but also on upstream or downstream components.

In accordance with one or more illustrative embodiments, an AI conversation system builder first obtains a dependency graph that represents all the components, external systems, and interactions between these components and external systems, for a complex software system. The AI conversation system builder collects all the events and actions from the components of the complex software system and identifies the relationships between events and action across the various components from the collected information. The resulting data is plotted and arranged in a time series so as to be able to identify the pattern between actions and events. From this time series, and the identified patterns of actions and events, the changes in component event patterns for each action is determined across all the components. From these identified changes and correlations between event patterns and actions, relationships are generated and, for each relationship, a set of intents, entities, and their relationships are generated. From the various relationships between events, actions, and components obtained through the above process, actions-component-event (ACE) relationship mappings are generated. These actions-components-events relationship mappings are then used as the basis for configuring an AI conversation model which may interact with software developers to assist with handling events occurring with components in complex software systems, leveraging the relationships learned through the above process.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides automated mechanisms for generating and configuring an AI conversation model based on learned event, action, and component state relationships of complex software systems. The improved computing tool implements mechanism and functionality, such as the AI conversation model generator, which cannot be practically performed by human beings either outside of, or with the assistance of, a technical environment, such as a mental process or the like. The improved computing tool provides a practical application of the methodology at least in that the improved computing tool is able to generate an AI conversation model and configure it to interact with human developers in addressing problem events appropriately based on learned event, action, and component relationships.

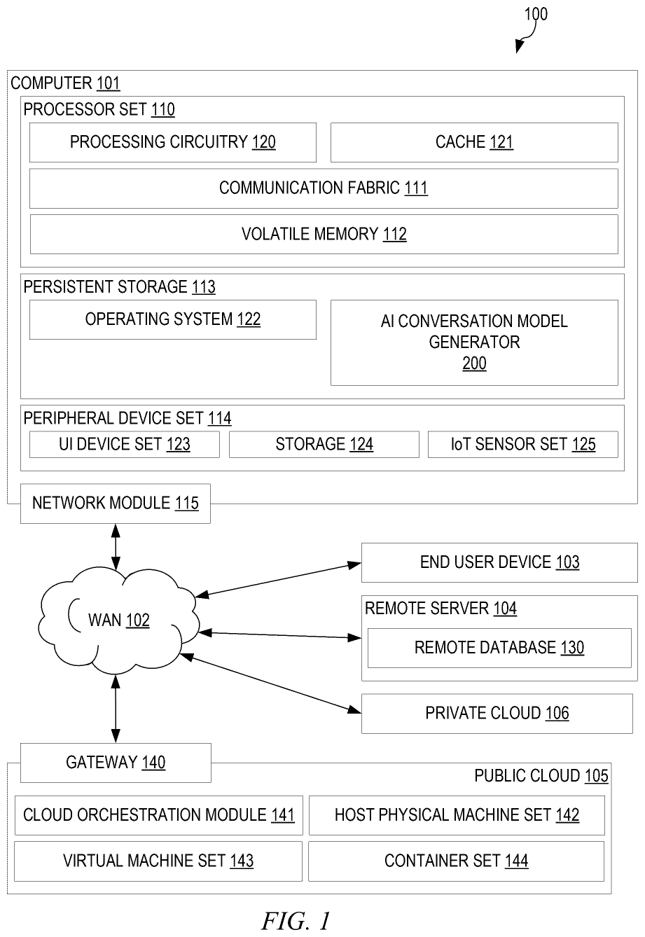

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as AI conversation model generator 200. In addition to AI conversation model generator 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and AI conversation model generator 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in AI conversation model generator 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in AI conversation model generator 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a AI conversation model generator 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates the generation of an AI conversation model that can interact with human developers to assist them with the diagnosing and resolving of problem events in complex software systems.

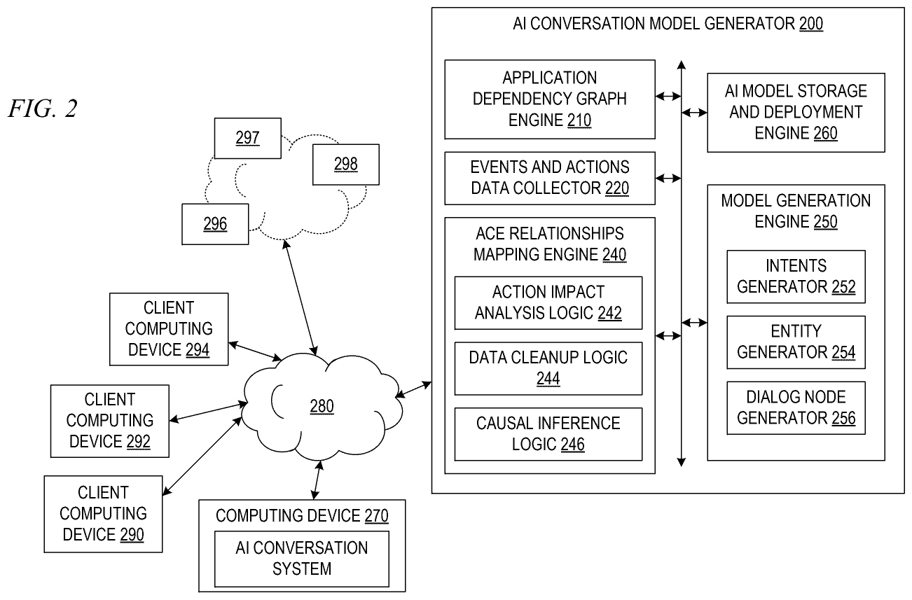

FIG. 2 is an example block diagram illustrating the primary operational components of an AI conversation model generator in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that diagnosing and addressing problem events in complex software systems are performed, and providing a specific solution that implements generation and configuring of an AI conversation model to interact with human developers to provide guidance in addressing problem events, cannot be practically performed by human beings as a mental process and is not directed to organizing any human activity.

As shown in FIG. 2, the AI conversation model generator 200 comprises an application dependency graph engine 210, an events and actions data collector 220, a key field identifier engine 230, an actions-components-events (ACE) relationships mapping engine 240, a model generation engine 250, and an AI conversation model storage and deployment engine 260. The AI conversation model generator 200 may operate in conjunction with one or more computing devices 270 via one or more data networks 280 for both deployment of an AI conversation model for interaction with human users, and/or for interaction with human users via client computing devices 290-294 to address events occurring in a complex software system hosted by one or more computing systems 296-298, such as cloud computing systems, for example. Thus, for example, the subject of the generation of an AI conversation model may be a given complex software system comprising components provided by various providers across multiple computing systems, cloud computing systems, and the like, represented in FIG. 2 as computing systems 296-298. Thus, these complex computing systems may span multiple different providers, multiple different computing systems, multiple different data networks 280, multiple different geopolitical boundaries, and the like. The AI conversation model generator 200 learns the components of this complex software system, their relationships, and relationships between actions, components, and events occurring within the complex software system, and generates and configures an AI conversation model that provides an automated artificial intelligence tool to interact with human users to address problem events occurring within the complex software system.

In order to generate the AI conversation model, the AI conversation model generator 200 first obtains information about the various components of the complex software system. That is, the application dependency graph engine 210 collects information regarding the structure of the complex software system and generates a dependency graph data structure representing the dependencies between the various components of the software system. The dependency graph may be generated using known tools that observe and produce dependency graphs. For example, a known tool that may be utilized for this purpose may be the IBM Instana® monitoring tool, available from International Business Machines (IBM®) Corporation of Armonk, New York, which creates a dependency graph by analyzing a deployment.

In order to generate the dependency graph data structure for the complex software system, the code of the components of the software system is parsed and analyzed to identify calls and returns between components, between components and external systems, and the like. That is, by parsing through the code of a first component (component 1), the application dependency graph engine 210 may identify a call to component 2, a call to component 4, an access to a database (db1), an output to a user interface (UI), and the like. Similarly, these interactions may be followed to these other components and external systems to trace their interactions and determine further components and external systems that are part of the complex software system (also referred to herein as the “application”).

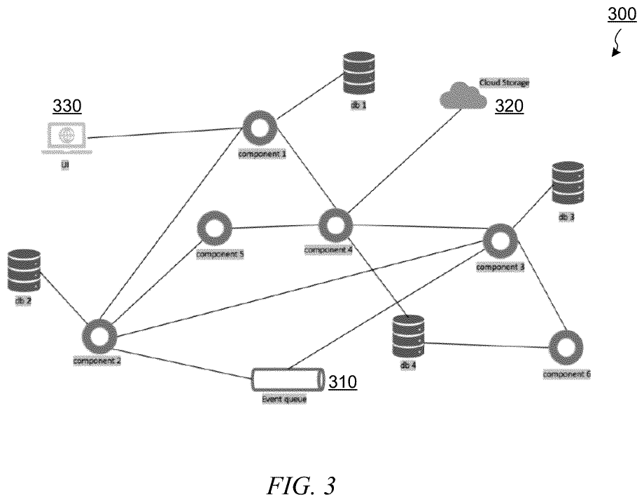

An example of a dependency graph data structure is graphically represented in FIG. 3. As shown in FIG. 3, the dependency graph 300 represents all the components and external systems that make up a software system, as well as the interactions between these components and external systems. The dependency graph 300 further represents the flow of data/events between the components and the sequence traversed for completion of a specific request.

As shown in FIG. 3, various components 1 to 6 of the software system are identified and their relationships with each other, as represented by the links between components 1 to 6 shown in FIG. 3. Moreover, various ones of the components have relationships with external components, i.e., components that are not part of the application itself but necessary for the application to perform its operations, such as databases db1 to db4, event queues 310, cloud storages 320, and user interfaces (UIs) 330. It should be appreciated that while FIG. 3 shows the dependency graph as a graphical representation, within the AI conversation model generator 200, this dependency graph will be represented as one or more data structures detailing the components, their attributes, their connections or relationships, and similar information about external systems and components and their relationships with the components.

Thus, returning to FIG. 2, the application dependency graph engine 210 generates the dependency graph data structure(s) for representing the complex software system, an example of which is shown in FIG. 3. In addition, the events and actions data collector 220 collects data, such as from logs and the like of each of the components, representing all the events and actions taken by the components in the deployment of the application (complex software system). This event and action data may be obtained, for example, using existing monitoring tools, such as IBM Instana®, which captures metrics for each event and action performed on a system (deployment). One or more events data structures may be generated by analyzing the collected data and extracting significant features from the collected data representing the events and actions for determining action-component-event (ACE) relationships. This analysis and extraction of significant features may include application of the key field identifier engine 230 that identifies key fields in the collected data for populating event and/or action data structures for components.

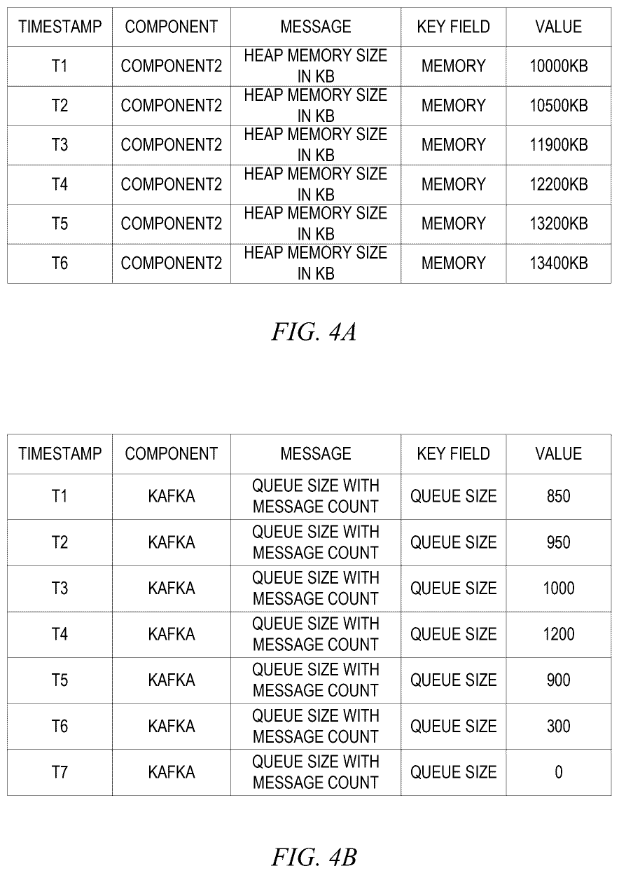

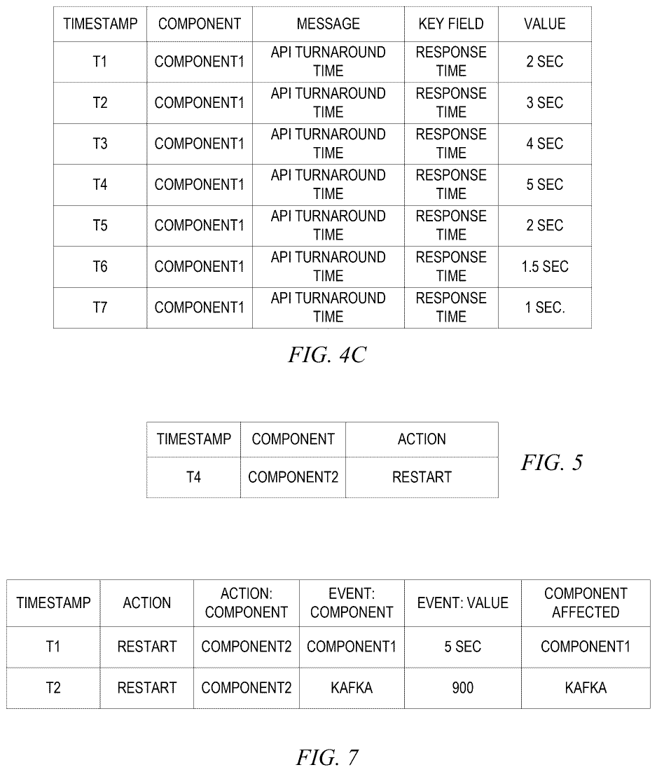

FIGS. 4A-4C are example tables of events in accordance with one illustrative embodiment. The table of events data structure 410 in FIG. 4A is a set of events for various timestamps T1 to T6 for component 2 in FIG. 3. These events are with regard to memory consumption and are extracted from the collected data. It should be appreciated that similar event and/or action data structures may be generated for each component and for each type of event in a plurality of types of events and plurality of components. The particular types of events and corresponding data/fields to extract from the collected data may be specified in configuration information for the key field identifier engine 230 for each type of component.

As shown in FIG. 4A, for memory consumption events, at each timestamp T1 to T6 the corresponding event has a component identifier (Component2), a message (e.g., “Heap memory size in KB”), a key field extracted from the collected data (e.g., “Memory” field), and a value extracted from the event data collected, which in this case represents an amount of memory consumption by the identified component at that timestamp. The message provides a description of the event and/or extracted fields. The key field specifies what the value represents, which in this case is an amount of memory. The value specifies the quantitative measure corresponding to the event. It should be appreciated that while FIG. 4A shows only one type of event, i.e., memory consumption, in some illustrative embodiments an event data structure may comprise information for key fields extracted from the collected data for various different types of events and/or different components. Alternatively, separate event data structures may be generated for different combinations of components and/or event types.

FIG. 4B is an example of another set of events for a component, which in this case is a Kafka queue size event for a “Kafka” component, for timestamps T1 to T7. In this case, the extracted features from the collected event data comprises the timestamp, the component, the message “Queue size with message count”, key field of “Queue Size”, and the corresponding values representing the quantitative measure of the queue size. FIG. 4C provides another example of an events data structure for component1 for time stamps T1 to T7 and for a performance metric of response time, which is an indicator of an API turnaround time.

FIG. 5 is an example table illustrating an action taken for a component in accordance with one illustrative embodiment. As with the events data extracted and used to populate the event data structures of FIGS. 4A-4C, similar extraction of fields and information from the collected data from the various components represented in the dependency graph data structure may be performed for actions taken in response to events. For example, in the depicted example of FIG. 5, at timestamp T4, an action is taken to restart Component2.

Thus, from the data structures generated by the events and actions data collector 220 and the analysis by the key field identifier engine 230 of the collected events and action data, the actions-components-events (ACE) relationships mapping engine 240 comprises action impact analysis logic 242 to plot the data structures to identify relationships and specifically the actions which impact one or more components of the complex software system. In particular, the action impact analysis logic 242 of the ACE relationships mapping engine 240 takes each action specified in an action data structure, such as that shown in FIG. 5, and identifies the impacted events from one or more of the “values” specified in event data structures of one or more components. That is, the action impact analysis logic 242 looks for patterns in event data structures that are correlated with actions in action data structures and the same or related components, such as by correlating timestamps of events/actions relative to one another that are indicative of a cause-effect type relationship. This may be indicated by significant changes in values at timestamps within a predetermined range of an action timestamp, either before, during, or after the action's timestamp as specified in the action data structure. Moreover, the relatedness of components is indicated by the dependency graph data structure.

It should be appreciated that this analysis of the data structures generated from the analysis and extraction of information from the collected data may be performed by one or more AI computer models of the action impact analysis logic 242. That is, the action data structures, event data structures, and dependency graph data structure may be input to one or more AI computer models which analyze these inputs to identify patterns in these inputs and output a classification or prediction as to the impact of an action on events associated with components. For example, an action, event, and component relationship may be input to the AI computer model(s) and a classification is output as to whether the action impacts that event for that component. This may be done for every combination of action, event, and component to thereby obtain classifications for each combination. The resulting combinations that are indicated to have a classification of an impact of the action on the event of a component may then be used to generate an action-component-event (ACE) relationship.

For example, if a “value” of a component in an event data structure changes, e.g., the “value” rests to ground/zero/original value or an anti-pattern in “Value” is observed from the time the action was performed, then those components are considered to be impacted components. Put more simply, in this example embodiment, if there is a change in the pattern on “Value” after an action is performed, then those events are considered to be impacted events. Looking to FIGS. 4A-4C and 5, the action represented in the action data structure of FIG. 5 can be seen to have impacted the components of FIGS. 4B and 4C at timestamp T4. For example, the pattern of queue size in FIG. 4B is increasing until timestamp T4 after which the queue size decreases down to 0 at timestamp T7. Similarly, in FIG. 4C, the response time is increasing from timestamps T1 to T4 and then drops at timestamp T5 and thereafter. Looking at FIG. 4A it can be seen that the action of FIG. 5 does not have an appreciable impact on the values in FIG. 4A as the value does not change after timestamp T4. Thus, the event of restarting Component2 at timestamp T4 impacts the Kafka and Component1 components and their corresponding events.

It should be appreciated that more complex analysis may be used in addition to or in replacement of identifying a change in the pattern of values for a key field. For example, types of changes, significance of the change (such as may be specified by predetermined thresholds being met/exceeded), duration of the change (again in relation to predetermined thresholds of duration), particular combinations of components experiencing changes, and the like, may all be factors that may be considered when determining whether an action does indeed impact events of particular components. Any pattern of values, thresholds, and the like, may be used as a basis for determining whether an action represents an impact on components and events.

As noted above, in one or more of the illustrative embodiments, the action impact analysis logic 242 may employ trained AI computer model(s) to evaluate patterns in inputs and generate a corresponding classification or prediction based on the identified patterns and their correlations to particular classification/predictions. It should be appreciated that these AI computer models are specifically trained through machine learning training processes to perform their attributed specific functions, making them each application specific AI computer models. This machine learning training process for each AI computer model is based on a corresponding training dataset comprising examples of input features that represent the types of input features the AI computer model is expected to see during runtime operation. Moreover, the training dataset comprises ground truth labels which specify the correct output that the AI computer model should generate based on these input features if the AI computer model is operating properly. During the machine learning training process, the AI computer model receives a training data example as input, generates an output based on its current configuration, and that output is compared to the ground truth label to determine an error or loss. A machine learning training function is then applied to this error or loss to attempt to minimize this error or loss. Based on the application of the machine learning training function, modifications of the AI computer model's internal configuration parameters are made to implement this minimization of the error or loss. This process is repeated for each example in the training dataset and may be repeated over a plurality of iterations or epochs until a convergence criteria is met, e.g., a predetermined number of iterations have occurred or the error/loss is reduced down to a predetermined threshold or less. Once trained, a testing dataset, similar to the training dataset, may be applied to verify the performance of the AI computer model prior to deployment of the AI computer model for runtime operation against previously unseen combinations of input features.

It should be appreciated that in some illustrative embodiments, the AI computer models may be previously trained language models (LMs) or large language models (LLMs) which may use prompt inputs that specify to the LM/LLM what their function is, what tools they can use, the context upon which the LM/LLM is to operate, and what types of outputs that the LM/LLM is to generate. That is, rather than having to train specific AI computer models as in the above description, in some illustrative embodiments, the mechanisms of the present invention may leverage the power of previously trained LM/LLMs, which are trained on a vast amount of input data but are more generally trained. The specific prompts input to the LM/LLM narrow the focus of the LM/LLM to the particular inputs and function that is desired to be performed, thereby fine-tuning the LM/LLM to the particular function, e.g., “you are a classifier that classifies the input to determine if the action impacts the events of the components” or the like, with the context being the event and action data structures, for example These prompts may be generated based on predefined templates which are then populated with the specific input feature values and context information to thereby generate the specific prompt.

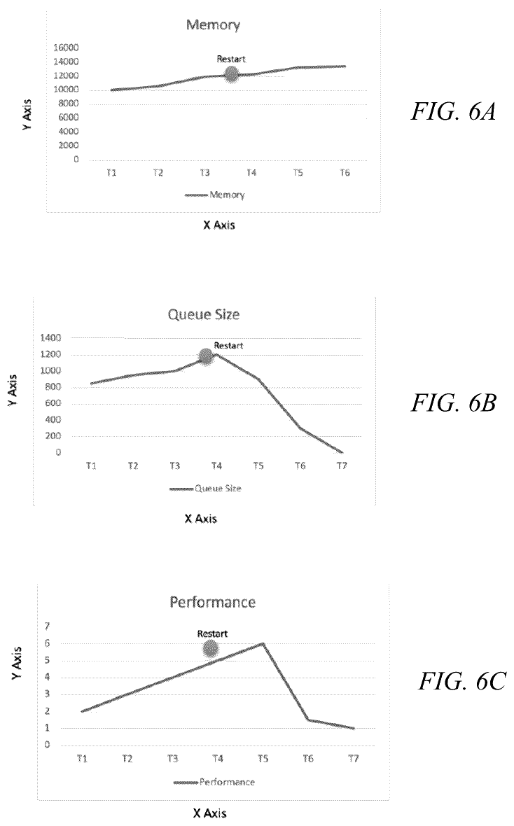

In some illustrative embodiments, the action impact analysis logic 242 of the ACE relationships mapping engine 240 may plot the data in the various event and action data structures, e.g., FIGS. 4A-4C and 5, and correlate these plots to identify significant changes in event values in relation to the occurrence of an action. FIGS. 6A-6C are example plots for events and actions in accordance with one illustrative embodiment and the example data structures of FIGS. 4A-4C and 5. FIG. 6A is a plot of the key field's corresponding values as shown in FIG. 4A along with the restart action from FIG. 5. FIGS. 6B and 6C provide similar plots of the key fields'corresponding values as shown in FIGS. 4B and 4C along with the restart action from FIG. 5. From these plots one can see that, with the overlay of the action from FIG. 5 onto the plots that in FIG. 6A, after the restart action at time T4, there is no change in the Y-axis value and thus, Component1's memory consumption is not impacted by the action taken on Component1. However, looking at FIG. 6B, after the restart action at time T4, one can see that the Kafka queue size is decreasing in the Y-axis value and thus, the Kafka queue consumption is increased by the action taken on Component1. Similarly, looking at FIG. 6C, after the restart action at time T4, one can see that Component2's API response time is decreasing in the Y-axis value and thus, Component2's performance increases by the action taken on Component1.

Thus, from these plots and analysis, or analysis of the data structures of FIGS. 4A-4C and 5 themselves, the action impact analysis logic 242 is able to identify which components and events are impacted by the given action. In the depicted example, the action in FIG. 5 impacts events of FIGS. 4B and 4C. This leads to the generation of ACE relationships which may then be used to configure an AI conversation schema for an AI conversation model. For example, a first ACE relationship may be that a restart of Component1 will increase the Kafka queue consumption of a related Kafka Queue. A second ACE relationship may be that a restart of Component1 will increase API response time performance of a related Component2.

The ACE relationship mapping engine 240 further comprises data cleanup logic 244 and causal inference logic 246. As data is collected over a time series, noise can be introduced into the collected data, i.e., random fluctuations and irrelevant variations. Thus, the data cleanup logic 244 may operate to clean this noise and ensure that the collected data is accurate and reliable. Cleaning the noise involves various known techniques, such as smoothing, filtering, outlier removal, and the like, which assist in highlighting the true underlying patterns and relationships within the collected data. Any such cleanup technologies may be used with the mechanisms of the illustrative embodiments to perform cleanup of the collected data prior to or after generation of the ACE relationships. For example, the data cleanup logic 244 may operate to remove duplicate data, which may include performing fuzzy matching, cosine similarity, deduplication methods, or any other suitable technique for removing duplicate data.

Once the data is cleaned by the data cleanup logic 244, the causal inference logic 246 performs a causal inference operation using the one or more trained AI computer models noted above to rigorously identify and quantify the cause-and-effect relationships between actions and outcomes. By isolating the true causal relationships, casual inference ensures that the resulting model is not only accurate but also insightful, allowing for better predictions and more effective decision-making based on the actual drivers of change. That is, causal inference determines whether and how one variable (e.g., EVENT) directly influences another variable (e.g., ACTION) by analyzing data, removing noisy or irrelevant information, and establishing cause-and-effect relationships. Casual inference also identifies cause-and-effect relationships by analyzing data through statistical techniques (e.g., regression or propensity score matching), experimental designs, and/or AI models, such as causal Bayesian networks. While trained AI models can detect patterns, the causal inference of the illustrative embodiments goes beyond pattern recognition to explicitly determine how variables influence each other, including generating ACE relationships based on observed and inferred data dependencies.

FIG. 7 is an example diagram of an event table data structure after causal inference in accordance with one illustrative embodiment. The event table data structure 710 comprises the correlation between actions, events, and the affected components. This information may be determined from the ACE relationship analysis and causal inference by one or more AI computer models. As shown in FIG. 7, the event data structure specifies the timestamp, the action, the component on which the action was performed, and one or more event components. In addition, the event data structure comprise the event value, i.e., the value recorded for components at the event timestamp when the action was performed, and the component(s) affected, i.e., the component which has a change in event after the action is performed.

The ACE relationships represented in the event table data structure after performance of the causal inference may be provided to the model generation engine 250. The model generation engine 250 comprises an intents generator 252, an entity generator 254, and a dialog node generator 256. The intents generator 252 operates to identify the intents from the above impacted event data structures where the intents are the possible actions that can be performed on the objects (entities). In a first operation, the intents generator 252 identifies the primary verb, from the event data structure, that characterizes the value pattern occurring prior to the action that was performed, e.g., increasing, accumulating, piling, etc. The intent generator 254 identifies all synonyms for the identified primary verbs and then uses a static list of basic intents (without primary verb) for intent generations. The primary verb is merged with the static list of basic intents to generate a specific intent for the particular action-event-component (ACE) relationship. For example, if a primary verb of “piling” is determined to be present, a synonym for this primary verb is “increasing”, and the static listing comprises a basic intent of “how to fix”, then specific generated intents may be “how to fix piling” and “how to fix increasing”.

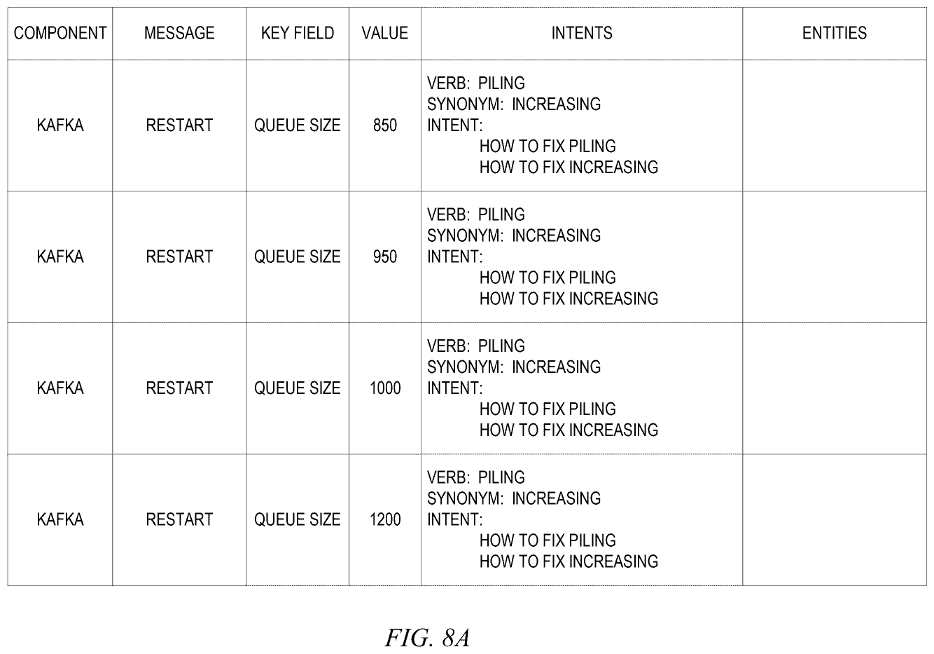

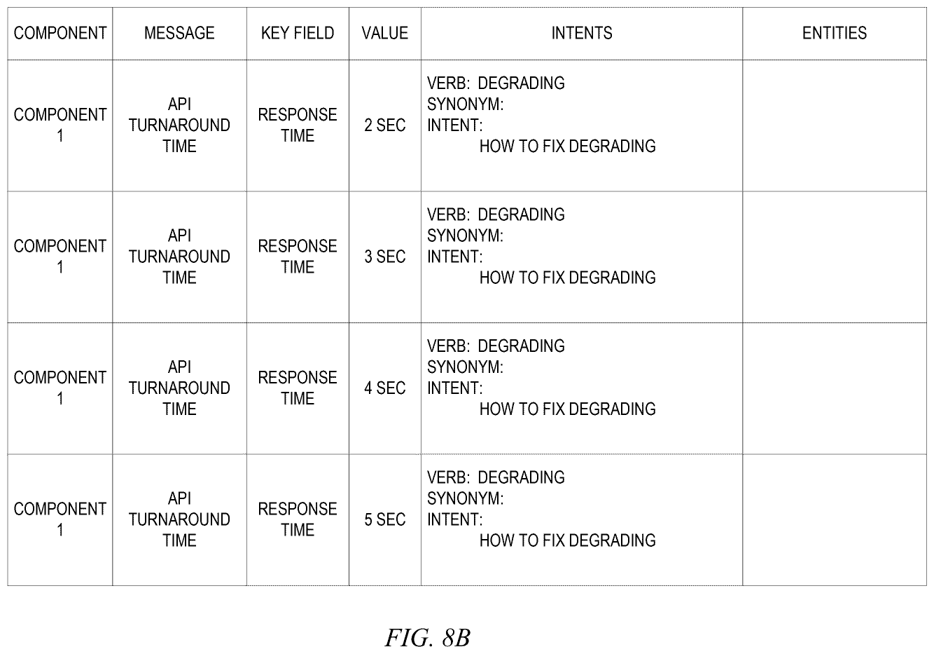

FIGS. 8A and 8B are example diagrams of a intents and entities table data structure corresponding to the identification of verbs from the event table data structure based on value change patterns in accordance with one illustrative embodiment. FIG. 8A shows a table data structure having intents for the Kafka queue and the events associated with queue size, such as in FIG. 4B above. In FIG. 8A, the intents use the examples above with regard to primary verb, synonym, and static listing of intents. FIG. 8B shows another table data structure having intents for Component1 and the events associated with API turnaround time and response time of the Component1. In this example, the static list of basic intents again has the intent “how to fix” but the primary verb in this case is “degrading”. There is no identified synonym in this case. Thus, the specific generated intents are “how to fix degrading”. It should be appreciated that these are only simplified examples and that the primary verbs, synonyms, and static listings may comprise many more elements than those shown in these simplified examples.

In addition to generating intents, the model generation engine 250 further generates entities for the intents via the entity generator 254. The entity generator 254 identifies entities in the component-events by processing the text message and/or “Component”, “Messages”, “Key Fields”, and “Value” fields to identify any nouns, quantities, or the like, indicative of entities which are present in these fields and their content. Natural language processing techniques can be used to perform this analysis and identify corresponding nouns, quantities, entities, etc. For example, looking again at FIG. 4B, from the component field, the noun “Kafka” may be identified. Moreover, in the Message field having message “Queue size with message count”, the nouns “queue size” and “message count” may be extracted.

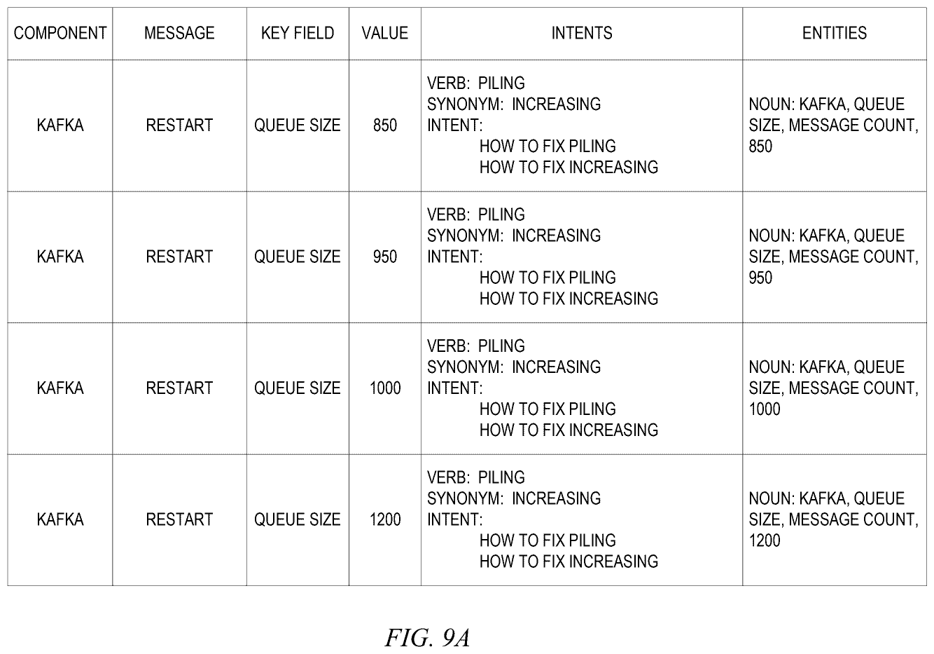

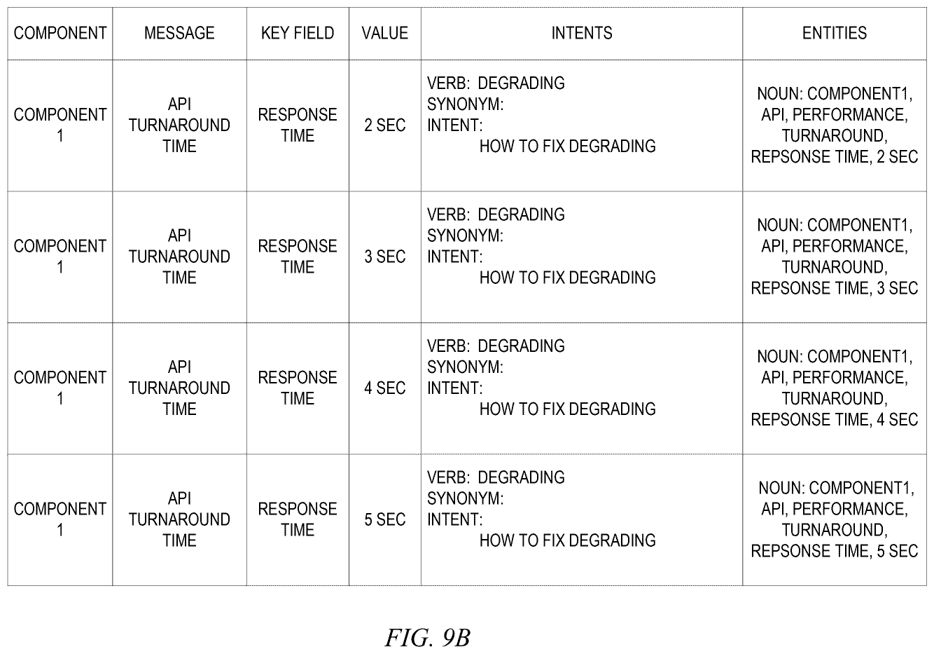

FIGS. 9A and 9B are example diagrams of an intents and entities table data structures corresponding to the identification of nouns and listed entities in accordance with one illustrative embodiment. As shown in FIGS. 9A and 9B, the table data structures of FIGS. 8A and 8B are augmented to include the listing of entities extracted from the event data structures for the corresponding components, events, and actions.

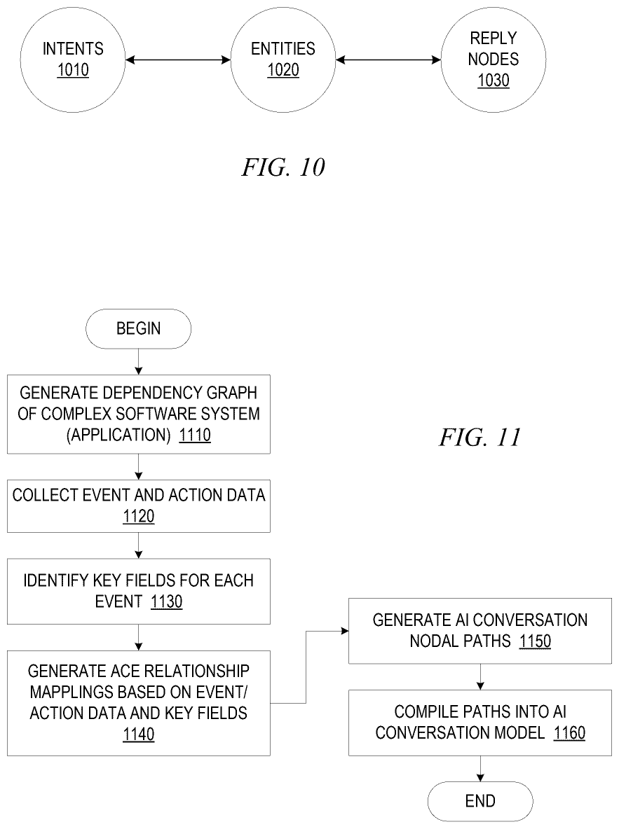

Based on the identified intents and entities in the intents and entities table data structures, and the actions, components and events identified in the actions of the ACE relationships, the dialog node generator 256 generates an AI conversation nodal graph for an AI conversation model. The dialog node generator 256 links the intents with the list of identified entities as specified in the intents and entities table data structures (e.g., see FIGS. 9A and 9B), as shown in FIG. 10. That is, the intents 1010 are linked to the entities 1020. The end node 1030 represents the AI conversation model's reply for the intents and entities. The reply actions in the reply nodes 1030 represent the actions identified in the actions data structure, i.e., the actions performed on the component that caused an impact on the other components. By using this nodal path, when a user inputs a request to the AI conversation system in which the AI conversation model is deployed, the Ai conversation model will cause the AI conversation system to respond in accordance with a given reply node.

For example, if a user inputs a question to the AI conversation system of the type “How do I fix degrading API performance on Component 1”, the text of the question may be processed using AI conversation system natural language processing and matched to an intent 1010 and entity 1020 pairing, e.g., in this case the intent would be “how to fix degrading” and the entity is “Component 1”. The event is “API performance”. These elements may be mapped to the nodal path shown in FIG. 10 and thus, a reply node of the type “Restart of Component1 should fix the API performance” may be returned from the AI conversation system. Similarly, if a user inputs a question of the type “How to fix piling up of Kafka message queue”, the AI conversation system can respond with “Restart of Component1 should fix the piling up of the Kafka message queue”.

The nodal paths generated for each ACE relationship identified through the mechanisms of the illustrative embodiments may be compiled into one or more dialog paths of one or more AI computer models for implementation by an AI conversation system. The generated AI conversation model may then be stored by the AI conversation model storage and deployment engine 260 and/or deployed for use by an AI computing system to handle user input, e.g., natural language questions, requesting assistance with diagnosing and addressing problem events occurring in the complex software system. It should be appreciated that this may be done for specific complex software systems such that a different AI conversation model and/or AI conversation system may be generated for each complex software system in a dedicated manner.

Thus, the illustrative embodiments provide an improved computing tool and improved computing tool operations/functionality for specifically configuring an AI conversation system for problem event resolution for a specific complex software system. The illustrative embodiments provide an AI conversation system builder that obtains a dependency graph that represents all the components, external systems, and interactions between these components and external systems, for a complex software system. The AI conversation system builder collects all the events and actions from the components of the complex software system and identifies the relationships between events and action across the various components from the collected information. The resulting data is plotted and arranged in a time series so as to be able to identify the pattern between actions and events. From this time series, and the identified patterns of actions and events, the changes in component event patterns for each action is determined across all the components. From these identified changes and correlations between event patterns and actions, relationships are generated and, for each relationship, a set of intents, entities, and their relationships are generated. From the various relationships between events, actions, and components obtained through the above process, actions-component-event (ACE) relationship mappings are generated. These actions-components-events relationship mappings are then used as the basis for configuring an AI conversation model which may interact with software developers to assist with handling events occurring with components in complex software systems, leveraging the relationships learned through the above process.

FIGS. 11-13 present flowcharts outlining example operations of elements of the present invention with regard to one or more illustrative embodiments. It should be appreciated that the operations outlined in FIGS. 11-13 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 11-13, and may, in some cases, make use of the results generated as a consequence of the operations set forth in FIGS. 11-13, the operations in FIGS. 11-13 themselves are specifically performed by the improved computing tool in an automated manner.

FIG. 11 is a flowchart outlining an example operation of an AI conversation model generator in accordance with one illustrative embodiment. As shown in FIG. 11, the operation starts by obtaining a dependency graph of the complex software system or application (step 1110). Event and action data is collected (step 1120) and key fields are identified for each event (step 1130). Action-Component-Event (ACE) relationship mappings are then generated based on the event and action data and the identified key fields (step 1140). From these ACE relationship mappings, AI conversation nodal paths are generated (step 1150) and compiled to provide an AI conversation model (step 1160). The operation then terminates. While the operation terminates in FIG. 11, it should be appreciated that the AI conversation model that is generated may be stored for later use and/or deployment to an AI conversation system for handling runtime user queries or inputs and providing responses specifying actions that can be taken to resolve problem events in accordance with the AI conversation model.

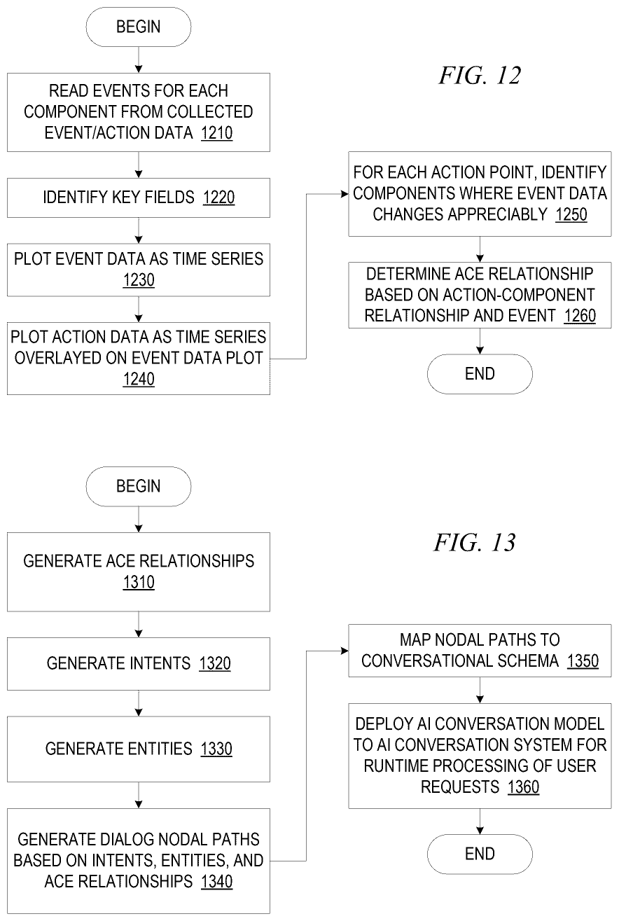

FIG. 12 is a flowchart outlining an example operation for generating action-component relationships in accordance with one illustrative embodiment. As shown in FIG. 12, the operation starts by reading events for each component from the collected event and action data (step 1210). The key fields of each event are identified (step 1220) and the event data is plotted in a time series, e.g. X-axis being the timestamp and the Y-axis being the key field value (step 1230). The action data is plotted on a time series and overlayed onto the event plots (step 1240), examples of which is shown in FIGS. 6A-6C. For each action point, components where the event data changes appreciably are identified (step 1250). An Action-Component relationship is generated for the event and thus, an Action-Component-Event (ACE) relationship is determined (step 1260). This may be repeated for each event such that a plurality of ACE relationships are generated. The operation then terminates.

FIG. 13 is a flowchart outlining an example operation for AI conversation model generation in accordance with one illustrative embodiment. As shown in FIG. 13, the operation starts by generating the ACE relationships (step 1310), such as in the process outlined in FIG. 12. Thereafter intents are generated (step 1320) and entities are generated (step 1330). Based on the generated intents, entities, and ACE relationships, dialog node paths are generated (step 1340) and compiled or mapped to a conversational schema (step 1350). The conversational schema defines an AI conversation model which is then deployed to an AI conversation system for processing user requests using the learned ACE relationships to solve problem events in the complex software system (step 1360). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating a dependency graph data structure for a complex software system, wherein the complex software system comprises components provided by a plurality of different providers;
collecting event and action data from the components of the complex software system specified in the dependency graph data structure;
identifying key fields for each event in the event and action data;
generating one or more action-component-event (ACE) relationship mappings based on the event and action data and the key fields;
generating one or more artificial intelligence (AI) conversation nodal paths based on the ACE relationship mappings; and
compiling the one or more AI conversation nodal paths into an AI conversation model for execution by an AI conversational system.

2. The method of claim 1, wherein generating one or more ACE relationship mappings comprises:
plotting a time series of event and action data based on the collected event and action data;
identifying identified patterns of actions and events in the time series; and
generating the one or more ACE relationship mappings based on the identified patterns.

3. The method of claim 2, wherein the identified patterns are changes in component event patterns across the components of the complex software system in response to actions specified in the event and action data.

4. The method of claim 1, wherein collecting event and action data from the components of the complex software system specified in the dependency graph data structure comprises, generating at least one first data structure comprising events corresponding to the components, and at least one second data structure comprising actions corresponding to the components, wherein entries in the at least one first data structure and the at least one second data structure comprise fields specifying timestamps and component identifiers for components in the complex software system associated with the entries.

5. The method of claim 4, wherein generating the one or more ACE relationship mappings based on the event and action data and the key fields comprises, for each action entry in each second data structure, analyzing key field values in entries of the at least one first data structure that are correlated with the action entry based on at least a timestamp of the action entry and timestamps of the entries in the at least one first data structure, to identify cause-effect type relationships between the action of the action entry and changes in key field values in entries of the one or more first data structures.

6. The method of claim 1, wherein generating one or more ACE relationship mappings based on the event and action data and the key fields comprises:
inputting the dependency graph and the key fields of the event and action data as input features to an artificial intelligence computer model trained to identify patterns in event and action data and classify the impact of the identified patterns in the event and action data;
processing, by the artificial intelligence computer model, the input features to generate a classification for each combination of an action and an event in the input features; and
generating the one or more ACE relationship mappings based on the classifications for each combination of actions and events in the input features.

7. The method of claim 6, wherein the artificial intelligence computer model is a pre-trained language model that is fine-tuned trained for identifying patterns in event and action data and classifying the impact of the identified patterns in the event and action data.

8. The method of claim 1, wherein different key fields are identified for different events in the event and action data.

9. The method of claim 8, wherein for memory consumption events, the key fields comprises an amount of memory consumption by a corresponding component at a timestamp of the memory consumption event, wherein for queue size events, the key fields comprises a queue size of a queue component at a timestamp of the queue size event, and wherein for a response time event, the key fields comprise a response time of a corresponding component at a timestamp of the response time event.

10. The method of claim 1, wherein the complex software system is a cloud-based computing system, and wherein the components comprise a plurality of applications provided by the plurality of different providers.

11. A computer program product comprising:
one or more computer-readable storage media; and
program instructions stored on the one or more computer-readable storage media to perform operations comprising:
generating a dependency graph data structure for a complex software system, wherein the complex software system comprises components provided by a plurality of different providers;
collecting event and action data from the components of the complex software system specified in the dependency graph data structure;
identifying key fields for each event in the event and action data;
generating one or more action-component-event (ACE) relationship mappings based on the event and action data and the key fields;
generating one or more artificial intelligence (AI) conversation nodal paths based on the ACE relationship mappings; and
compiling the one or more AI conversation nodal paths into an AI conversation model for execution by an AI conversational system.

12. The computer program product of claim 11, wherein generating one or more ACE relationship mappings comprises:
plotting a time series of event and action data based on the collected event and action data;
identifying identified patterns of actions and events in the time series; and
generating the one or more ACE relationship mappings based on the identified patterns.

13. The computer program product of claim 12, wherein the identified patterns are changes in component event patterns across the components of the complex software system in response to actions specified in the event and action data.

14. The computer program product of claim 11, wherein collecting event and action data from the components of the complex software system specified in the dependency graph data structure comprises, generating at least one first data structure comprising events corresponding to the components, and at least one second data structure comprising actions corresponding to the components, wherein entries in the at least one first data structure and the at least one second data structure comprise fields specifying timestamps and component identifiers for components in the complex software system associated with the entries.

15. The computer program product of claim 14, wherein generating the one or more ACE relationship mappings based on the event and action data and the key fields comprises, for each action entry in each second data structure, analyzing key field values in entries of the at least one first data structure that are correlated with the action entry based on at least a timestamp of the action entry and timestamps of the entries in the at least one first data structure, to identify cause-effect type relationships between the action of the action entry and changes in key field values in entries of the one or more first data structures.

16. The computer program product of claim 11, wherein generating one or more ACE relationship mappings based on the event and action data and the key fields comprises:
inputting the dependency graph and the key fields of the event and action data as input features to an artificial intelligence computer model trained to identify patterns in event and action data and classify the impact of the identified patterns in the event and action data;
processing, by the artificial intelligence computer model, the input features to generate a classification for each combination of an action and an event in the input features; and
generating the one or more ACE relationship mappings based on the classifications for each combination of actions and events in the input features.

17. The computer program product of claim 16, wherein the artificial intelligence computer model is a pre-trained language model that is fine-tuned trained for identifying patterns in event and action data and classifying the impact of the identified patterns in the event and action data.

18. The computer program product of claim 11, wherein different key fields are identified for different events in the event and action data.

19. The computer program product of claim 18, wherein for memory consumption events, the key fields comprises an amount of memory consumption by a corresponding component at a timestamp of the memory consumption event, wherein for queue size events, the key fields comprises a queue size of a queue component at a timestamp of the queue size event, and wherein for a response time event, the key fields comprise a response time of a corresponding component at a timestamp of the response time event.

20. A computer system comprising:
a processor set;
one or more computer-readable storage media; and
program instructions stored on the one or more computer-readable storage media to cause the processor set to perform operations comprising:
generating a dependency graph data structure for a complex software system, wherein the complex software system comprises components provided by a plurality of different providers;
collecting event and action data from the components of the complex software system specified in the dependency graph data structure;
identifying key fields for each event in the event and action data;
generating one or more action-component-event (ACE) relationship mappings based on the event and action data and the key fields;
generating one or more artificial intelligence (AI) conversation nodal paths based on the ACE relationship mappings; and
compiling the one or more AI conversation nodal paths into an AI conversation model for execution by an AI conversational system.
